(19) United States
(12) Patent Application Publication
(10) Pub. No.: US 2005/0094803 A1
(43) Pub. Date: May 5, 2005

(54) Telephone exchange apparatus and network telephone system

(75) Inventor: Takashi Watanabe, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 10/958,341

(22) Filed: Oct. 6, 2004

(30) Foreign Application Priority Data
Oct. 31, 2003 (JP) 2003-372444

(51) Int. Cl. H04M 1/24; H04M 3/22

(52) U.S. Cl. 379/406.01

(57) ABSTRACT

A telephone exchange apparatus includes a plurality of first interfaces each of which connects a first communication line for transmitting a voice packet and comprises an echo canceller that cancels an echo added to the voice packet, a second interface which connects a second communication line for transmitting an analog voice signal, and a controller which selectively connects between the first interfaces and between at least one of the first interfaces and the second interface, and controls the execution and stopping of the processing of the echo canceller according to a call setting request.

### CROSS-REFERENCE TO RELATED APPLICATIONS

This application is based upon and claims the benefit of priority from prior Japanese Patent Application No. 2003-372444, filed Oct. 31, 2003, the entire contents of which are incorporated herein by reference.

### BACKGROUND OF THE INVENTION

1. Field of the Invention

The present invention relates to a telephone exchange apparatus to which an internet protocol (IP) network to transmit a voice packet can be connected and which has an echo canceller function of canceling an echo that is added to the voice packet. The invention also relates to a network telephone system to which a plurality of telephone exchange apparatuses are connected via the IP network.

2. Description of the Related Art

In recent years, the following system is proposed. A network telephone terminal (i.e., an internet Protocol (IP) telephone terminal) having a telephone call processing function and a media information processing function is connected to a local area network (LAN). The LAN is connected to an external communication network such as a public network via a main apparatus. The IP telephone terminal and the main apparatus carry out a protocol conversion and a data format conversion. With this arrangement, communications can be achieved between the IP telephone terminals and between the IP telephone terminal and the external communication network.

In this type of system, an echo is added to a voice signal when the IP telephone terminal is connected to an office line in the main apparatus. To overcome this problem, a main apparatus that has an echo canceller function of canceling the echo added to the voice signal is investigated, as disclosed (see, for example, Document 1: U.S. Pat. No. 6,404,887, B1).

The echo canceller function is incorporated in an IP interface unit that connects the IP telephone terminal. This function works effectively when the IP telephone terminal is connected with the office line. However, when the IP telephone terminals having small influence of the echo are connected to each other, the echo canceller function becomes unstable. Particularly, in the IP telephone system, a plurality of main apparatuses are connected via the IP network. In this case, the echo cancellers are in multiple connection, which makes the echo canceling operation unstable.

### BRIEF SUMMARY OF THE INVENTION

It is an object of the present invention to provide a telephone exchange apparatus and a network telephone system capable of effectively canceling the echo added to the voice signal even when a plurality of mutually different communication lines are handled or when the echo cancellers are in multiple connection.

According to an aspect of the present invention, there is provided a telephone exchange apparatus comprising: a plurality of first interfaces each of which connects a first communication line for transmitting a voice packet and comprises an echo canceller that cancels an echo added to the voice packet; a second interface which connects a second communication line for transmitting an analog voice signal; and a controller which selectively connects between the first interfaces and between at least one of the first interfaces and the second interface, and controls the execution and stopping of the processing of the echo canceller according to a call setting request.

According to another aspect of the present invention, there is provided a network telephone system which comprises two or more telephone exchange apparatuses each of which connects between a first communication line for transmitting a plurality of voice packets and a second communication line for transmitting an analog voice signal, and connects between a plurality of the telephone exchanges with a third communication line for transmitting a voice packet, the network telephone system comprising: a first interface which connects the first communication line, and comprises an echo canceller which cancels an echo added to the voice packet, in each of the plurality of telephone exchange apparatuses; a second interface which connects the second communication line, in each of the plurality of telephone exchange apparatuses; a third interface which connects the third communication line, and comprises an echo canceller that cancels an echo added to the voice packets, in each of the plurality of telephone exchange apparatuses; a deciding circuit to decide a connection request origin and a connection request destination in a receiver-side telephone exchange, to generate a result of decision, when the connection request using the third communication line occurs; and a controller which controls execution and stopping of the echo canceller processing based on the result of decision.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a diagram of an approximate configuration of an exchange system according to a first embodiment of the present invention.

FIG. 2 is a diagram showing a relationship between number of echo cancellers in multiple connection and an echo convergence time.

FIG. 3 is a flowchart of control procedure of the echo canceller according to the first embodiment.

FIG. 4 is a diagram of an approximate configuration of an exchange system according to a second embodiment of the present invention.

FIG. 5 is a flowchart of an incoming call processing operation of a main apparatus as a call origin according to the second embodiment.

FIG. 6 is a flowchart of an echo canceller control procedure of a main apparatus as a call destination according to the second embodiment.

### DETAILED DESCRIPTION OF THE INVENTION

The embodiment of the present invention will be explained in detail with reference to the drawings.

(First Embodiment) FIG. 1 is a diagram of an approximate configuration of an exchange system according to a first embodiment of the present invention.

As shown in FIG. 1, the exchange system includes a main apparatus 1, and a plurality of IP telephone terminals 2 (2-1 to 2-i) and 3 (3-1 to 3-j) that are connected optionally to the main apparatus 1 via LANs 4 and 5 respectively.

The main apparatus 1 has a control unit 11, IP extension interface circuits 12 and 13 (hereinafter referred to as IP extension I/Fs 12 and 13), and an office line interface circuit 14 (hereinafter referred to as an office line I/F 14). The control unit 11, the IP extension I/Fs 12 and 13, and the office line I/F 14 are connected to each other via a bus 15.

The control unit 11 optionally exchanges and connects the IP extension I/Fs 12 and 13 and the office line I/F 14.

The IP telephone terminal 2 is connected to the IP extension I/F 12 when necessary. The IP extension I/F 12 carries out an extension interface operation concerning the connected IP telephone terminal 2. The IP extension I/F 12 also gives and receives various kinds of control information concerning the extension interface operation with the control unit 11 via the bus 15.

The IP telephone terminal 3 is connected to the IP extension I/F 13 when necessary. The IP extension I/F 13 carries out an extension interface operation concerning the connected IP telephone terminal 3. The IP extension I/F 13 also gives and receives various kinds of control information concerning the extension interface operation with the control unit 11 via the bus 15.

An office line L to be connected to a public network NW is connected to the office line I/F 14 when necessary. The office line I/F 14 carries out the interface operation concerning the connected office line L. The office line I/F 14 also gives and receives various kinds of control information concerning the interface operation with the control unit 11 via the bus 15.

The IP extension I/Fs 12 and 13 have echo cancellers 121 and 131 respectively that cancel an echo added to the voice signal. The control unit 11 controls to execute or stop a processing of the echo cancellers 121 and 131.

The operation of the exchange system having the above configuration will be explained next.

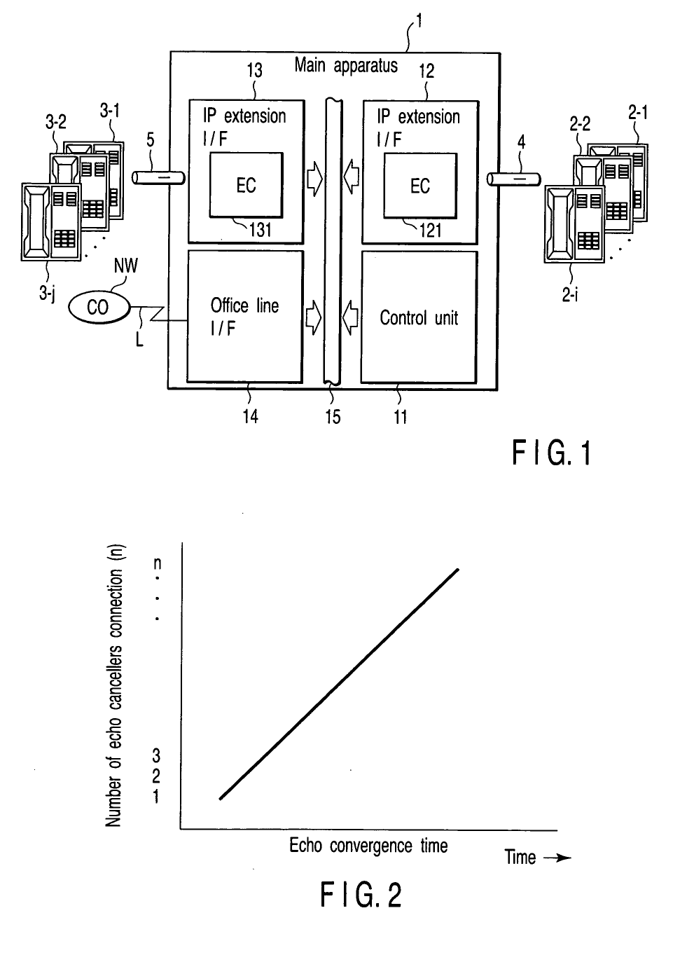

When telephone calls are carried out between the IP telephone terminal 2-1 and the IP telephone terminal 3-1, the echo cancellers 121 and 131 are in multiple connection. In general, when the echo cancellers 121 and 131 are in multiple connection, the convergence time of echo may become long, or the echo may not be converged in the worst case, as shown in FIG. 2.

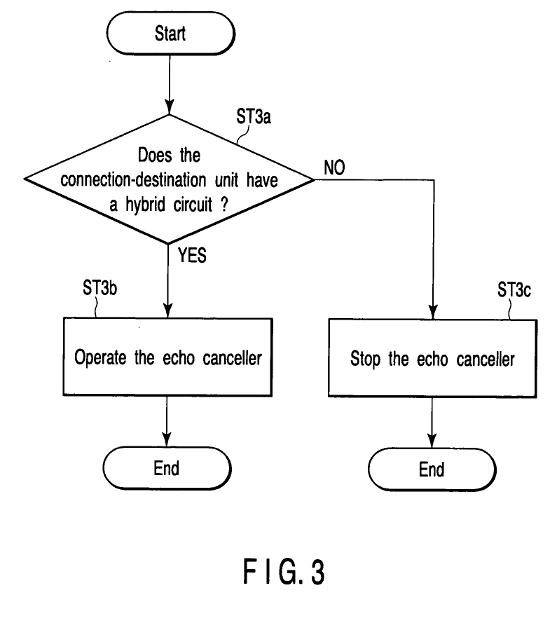

To cope with this situation, the control unit 11 controls to execute or stop the echo cancellers 121 and 131 according to the call setting request. FIG. 3 is a flowchart of the processing operation of the control unit 11.

Assume that the IP telephone terminal 2-1 transmits a call to a subscriber telephone terminal of the pubic network NW, and that the incoming call arrives at the main apparatus 1 via the LAN 4 accordingly. Then, the IP extension I/F 12 detects the incoming call, and notifies the arrival of the incoming call to the control unit 11 via the bus 15.

The control unit 11 analyzes the dial number of a call destination based on the notified incoming call, and decides whether a call destination unit has a hybrid circuit based on the result of the analysis (step ST3a). When the control unit 11 decides that the call destination is the public network NW (YES at step ST3a), the control unit 11 operates the echo canceller 121 (step ST3b).

On the other hand, assume that the IP telephone terminal 2-1 transmits a call to the IP telephone terminal 3-2, and that the incoming call arrives at the main apparatus 1 via the LAN 4 accordingly. When the control unit 11 decides that the call destination is the IP telephone terminal 3-2 (NO at step ST3a), the control unit 11 stops the echo cancellers 121 and 131 (step ST3c).

When the call origin is a subscriber telephone terminal of the public network NW, a similar processing operation is carried out.

As explained above, according to the first embodiment, the control unit 11 has the control function of executing or stopping the processing of the echo cancellers 121 and 131. Therefore, when the IP extension I/Fs 12 and 13 having small influence of echo are connected, the control unit 11 controls to stop the echo cancellers 121 and 131. When the IP extension I/F 12 is connected to the office line I/F 14, the control unit 11 controls to execute the echo canceller 121. In this way, only an optimum echo canceller can be operated for each connected communication line.

(Second Embodiment)

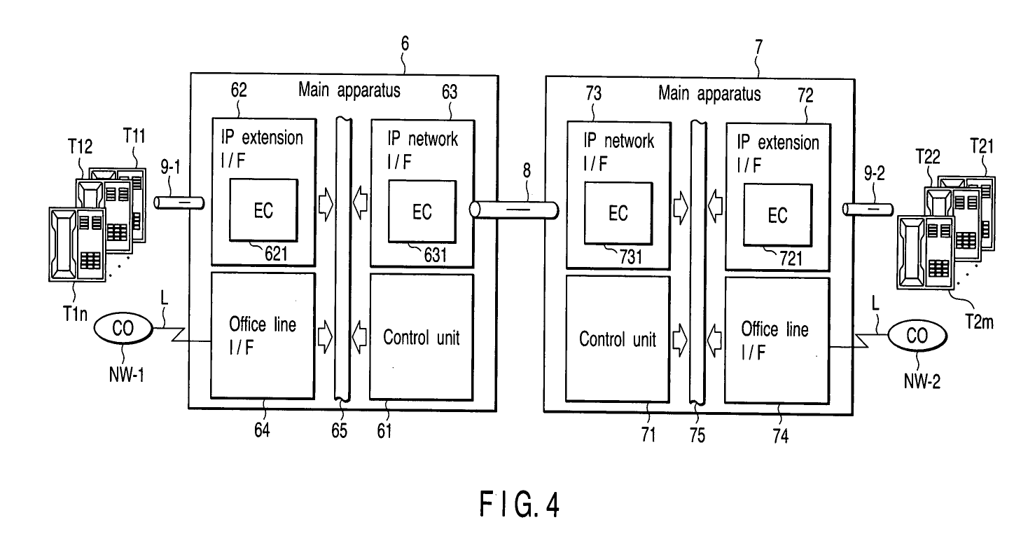

FIG. 4 is a diagram of an approximate configuration of an exchange system according to a second embodiment of the present invention.

As shown in FIG. 4, the exchange system has main apparatuses 6 and 7 that are connected to each other via a LAN 8. The main apparatus 6 optionally connects each of a plurality of IP telephone terminals T1 (T11 to T1n) via a LAN 9-1. The main apparatus 7 optionally connects each of a plurality of IP telephone terminals T2 (T21 to T2m) via a LAN 9-2.

The main apparatus 6 has a control unit 61, an IP extension interface circuit 62 (hereinafter referred to as an IP extension I/F 62), an IP network interface circuit 63 (hereinafter referred to as a network I/F 63), and an office line interface circuit 64 (hereinafter referred to as an office line I/F 64). The control unit 61, the IP extension I/F 62, the network I/f 63, and the office line I/F 64 are connected to each other via a bus 65.

The control unit 61 optionally exchanges and connects the IP extension I/F 62, the network I/F 63, and the office line I/F 64.

The IP telephone terminal T1 is connected to the IP extension I/F 62 when necessary. The IP extension I/F 62 carries out an extension interface operation concerning the connected IP telephone terminal T1. The IP extension I/F 62 also gives and receives various kinds of control information concerning the extension interface operation with the control unit 61 via the bus 65.

The LAN 8 is connected to the network I/F 63 when necessary. The network I/F 63 carries out the extension interface operation concerning the connected LAN 8. The network I/F 63 also gives and receives various kinds of control information concerning the extension interface operation with the control unit 61 via the bus 65.

The office line L to be connected to a public network NW-1 is connected to the office line I/F 64 when necessary. The office line I/F 64 carries out the interface operation concerning the connected office line L. The office line I/F 64 also gives and receives various kinds of control information concerning the interface operation with the control unit 61 via the bus 65.

The IP extension I/F 62 and the network I/F 63 have echo cancellers 621 and 631 respectively that cancel the echo added to the voice signal. The control unit 61 controls to execute or stop the processing of the echo cancellers 621 and 631.

On the other hand, the main apparatus 7 has a control unit 71, an IP extension interface circuit 72 (hereinafter referred to as an IP extension I/F 72), an IP network interface circuit 73 (hereinafter referred to as a network I/F 73), and an office line interface circuit 74 (hereinafter referred to as an office line I/F 74). The control unit 71, the IP extension I/F 72, the network I/F 73, and the office line I/F 74 are connected to each other via a bus 75.

The control unit 71 optionally exchanges and connects the IP extension I/F 72, the network I/F 73, and the office line I/F 74.

The IP telephone terminal T2 is connected to the IP extension I/F 72 when necessary. The IP extension I/F 72 carries out an extension interface operation concerning the connected IP telephone terminal T2. The IP extension I/F 72 also gives and receives various kinds of control information concerning the extension interface operation with the control unit 71 via the bus 75.

The LAN 8 is connected to the network I/F 73 when necessary. The network I/F 73 carries out the extension interface operation concerning the connected LAN 8. The network I/F 73 also gives and receives various kinds of control information concerning the extension interface operation with the control unit 71 via the bus 75.

The office line L to be connected to a public network NW-2 is connected to the office line I/F 74 when necessary. The office line I/F 74 carries out the interface operation concerning the connected office line L. The office line I/F 74 also gives and receives various kinds of control information concerning the interface operation with the control unit 71 via the bus 75.

The IP extension I/F 72 and the network I/F 73 have echo cancellers 721 and 731 respectively that cancel the echo added to the voice signal. The control unit 71 controls to execute or stop the processing of the echo cancellers 721 and 731.

The operation of the exchange system having the above configuration will be explained next.

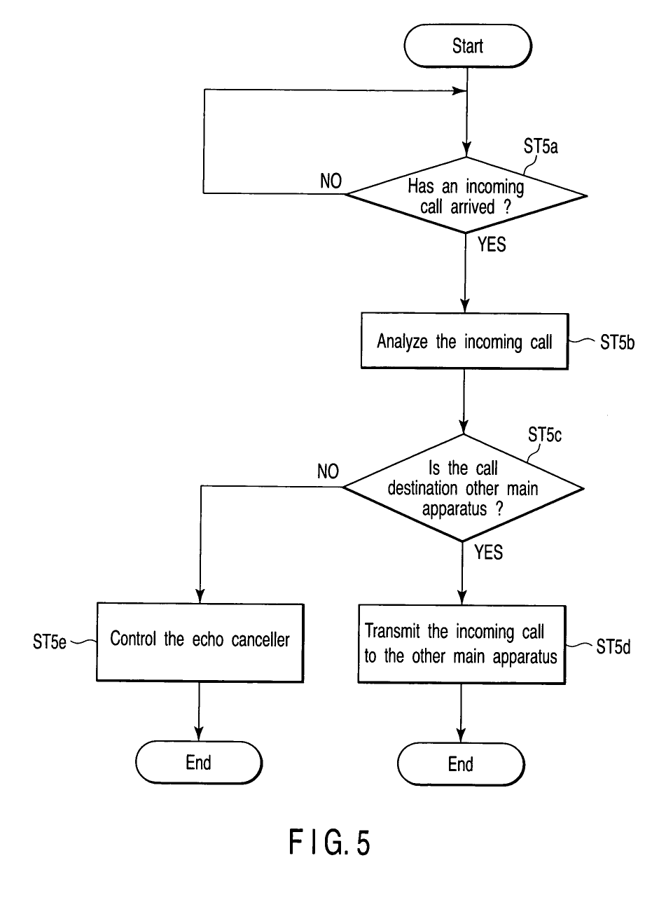

FIG. 5 is a flowchart of the processing operation of the control unit 61.

Assume that the IP telephone terminal T11 transmits a call to a subscriber telephone terminal of the public network NW-2, and that an incoming call arrives at the main apparatus 6 via the LAN 9-1 accordingly (step ST5a). Then, the IP extension I/F 62 detects the incoming call, and notifies the arrival of the incoming call to the control unit 61 via the bus 65.

The control unit 61 analyzes the dial number of a call destination based on the notified incoming call (step ST5b), and decides whether a call destination is the main apparatus 7 based on the result of the analysis (step ST5c). When the control unit 61 decides that the call destination is the main apparatus 7 (YES at step ST5c), the control unit 61 transmits the incoming call to the main apparatus 7 via the LAN 8 (step ST5d). In this case, the echo cancellers 621 and 631 are stopped.

On the other hand, when the call destination is the main apparatus 6 (NO at step ST5c), the control unit 61 controls the execution or stopping of the echo canceller 621 (step ST5e).

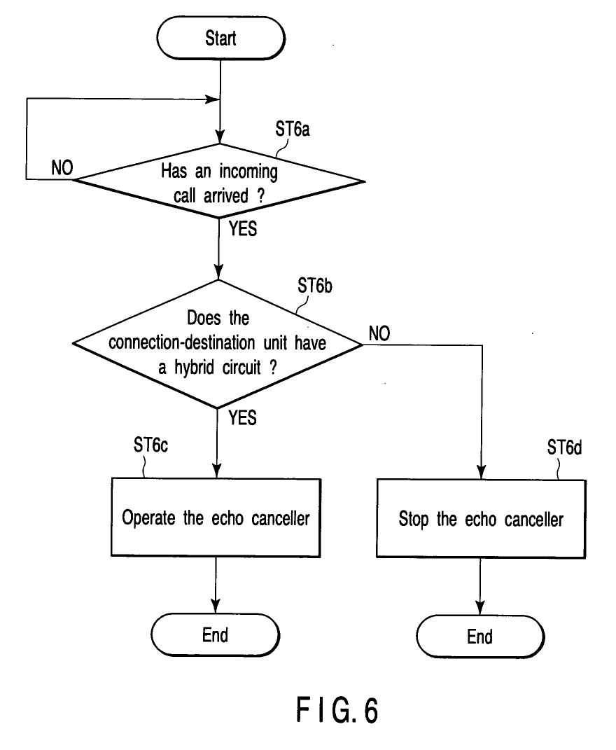

FIG. 6 is a flowchart of the processing operation of the control unit 71.

The control unit 71 always monitors the arrival of an incoming call (step ST6a). When an incoming call arrives (YES at step ST6a), the control unit 71 decides whether a call destination unit has a hybrid circuit (step ST6b). When the control unit 71 decides that the call destination is the public network NW-2 (YES at step ST6b), the control unit 71 operates the echo canceller 731 (step ST6c).

On the other hand, assume that the IP telephone terminal Tll transmits a call to the IP telephone terminal T21, and that an incoming call arrives at the main apparatus 7 via the LAN 8 accordingly. When the control unit 71 decides that the call destination is the IP telephone terminal T21 (NO at step ST6b), the control unit 71 stops the echo cancellers 721 and 731 (step ST6d).

When the call origin is a subscriber telephone terminal of the public network NW-1, a similar processing operation is carried out.

As explained above, according to the second embodiment, when the main apparatus 6 that receives the incoming call decides that the call destination is the public network NW-2, only the echo canceller 731 provided in the network I/F 73 within the main apparatus 7 is used.

Therefore, it is possible to prevent a wasteful use of the echo cancellers 621 and 631. Consequently, the effective utilization rate of the echo cancellers 621, 631, and 731 can be increased, and the whole system can reduce power consumption.

(Other Embodiments)

The present invention is not limited to the above embodiments. For example, the call origin is explained as the IP telephone terminal in the above embodiments. However, when the call origin is an analog telephone terminal and the call destination is the IP telephone terminal, the execution and stopping of the echo cancellers can be controlled in a similar manner.

While two main apparatuses are connected in the second embodiments, two or more main apparatuses can be also connected.

Configurations and types of the system, configurations and types of the exchange such as the main apparatus, and control procedures of the echo cancellers can be modified within a range not deviating from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A telephone exchange apparatus comprising:
a plurality of first interfaces each of which connects a first communication line for transmitting a voice packet and comprises an echo canceller that cancels an echo added to the voice packet;
a second interface which connects a second communication line for transmitting an analog voice signal; and
a controller which selectively connects between the first interfaces and between at least one of the first interfaces and the second interface, and controls the execution and stopping of the processing of the echo canceller, according to a call setting request.

2. The telephone exchange apparatus according to claim 1, wherein the controller controls to stop the echo canceller when connecting between the first interfaces.

3. The telephone exchange apparatus according to claim 1, wherein the controller controls to execute the echo canceller when connecting between at least one of the first interfaces and the second interface.

4. A network telephone system which comprises two or more telephone exchange apparatuses each of which connects between a first communication line for transmitting a plurality of voice packets and a second communication line for transmitting an analog voice signal, and connects between a plurality of the telephone exchanges with a third communication line for transmitting a voice packet, the network telephone system comprising:
a first interface which connects the first communication line, and comprises an echo canceller which cancels an echo added to the voice packet, in each of the telephone exchange apparatuses;
a second interface which connects the second communication line, in each of the plurality of telephone exchange apparatuses;
a third interface which connects the third communication line, and comprises an echo canceller that cancels an echo added to the voice packets, in each of the plurality of telephone exchange apparatuses;
a deciding circuit to decide a connection request origin and a connection request destination in a receiver-side telephone exchange, to generate a result of decision, when the connection request using the third communication line occurs; and
a controller which controls execution and stopping of the echo canceller processing based on the result of decision.

5. The network telephone system according to claim 4, when the request origin is the first communication line and the request destination is the second communication line connected to other telephone exchange apparatus based on the result of decision, wherein the controller executes only the echo canceller in the third interface of the other telephone exchange apparatus.

6. The network telephone system according to claim 4, when the request origin is the second communication line and the request destination is the first communication line connected to other telephone exchange apparatus based on the result of decision, wherein the controller executes only the echo canceller in the third interface of the telephone exchange apparatus that becomes receiver of the connection request.

7. The network telephone system according to claim 4, when the request origin is the first communication line and the request destination is the first communication line connected to other telephone exchange based on the result of decision, wherein the controller stops all the echo cancellers.
